(19) United States
(12) Patent Application Publication
(10) Pub. No.: US 2017/0124907 A1
(43) Pub. Date: May 4, 2017

(54) SYSTEM AND METHOD FOR ENABLING A USER TO OVERCOME LACK OF SELF CONTROL

(71) Applicants: Jonnalagadda Sasidhar, Sleepy Hollow, NY (US); Shanthi Lakshmi Duraimani, Bangalore (IN); Sreenidhi Sundaran, Bangalore (IN)

(72) Inventors: Jonnalagadda Sasidhar, Sleepy Hollow, NY (US); Shanthi Lakshmi Duraimani, Bangalore (IN); Sreenidhi Sundaran, Bangalore (IN)

(73) Assignee: DHARMA LIFE SCIENCES LLC, Sleepy Hollow, NY (US)

(21) Appl. No.: 14/985,475

(22) Filed: Dec. 31, 2015

Related U.S. Application Data
(63) Continuation-in-part of application No. 14/931,868, filed on Nov. 4, 2015.

(51) Int. Cl. G09B 19/00; G09B 5/02

(52) U.S. Cl. CPC G09B 19/00; G09B 5/02

(57) ABSTRACT

A system is provided for enabling a user to overcome lack of self control. The system is configured to enable the user to engage in a first and a second activity in a virtual environment, directed to rewire a first and a second defective wiring, respectively. The first defective wiring results in an individual's tendency to be biased towards short term gratification. The second defective wiring results in failure to weigh between short term gratification and long term outcome. Symptom of the first and the second defective wirings is lack of self control. Engagement in the second activity is enabled after the user has at least participated in the first activity. Automated instructions are provided to the user to engage in activities performed in a real world environment directed to rewire the first and the second defective wiring.

### CROSS REFERENCE TO RELATED APPLICATION

This application is a continuation-in-part application of U.S. patent application Ser. No. 14/931,868 filed Nov. 04, 2015 entitled SYSTEM AND METHOD FOR ENABLING A USER TO OVERCOME WEAK BEHAVIORAL TRAITS, which is hereby incorporated herein by reference. Benefits of priorities to all related applications are claimed.

### BACKGROUND

Unless otherwise indicated herein, the materials described in this section are not prior art to the claims in this application and are not admitted to be prior art by inclusion in this section.

The subject matter in general relates to behavioral traits in humans, and more particularly but not exclusively, the subject matter is directed to a technical solution to overcome lack of self-control, which is a weak behavioral trait.

An individual's behavior towards others, attitudes and characteristics, defines his personality. Each individual's personality is a combination of both positive and negative traits. A person may be driven by his positive traits at times and by negative traits at other times. As a result, to classify a person into a single personality type is difficult, as there are several different behavioral traits a person can have. Behavioral traits may be influenced by genes and/or by the environment where he grew up or may have spent most of his time during the stage of brain development. As an example, lack of self control may be caused by genetic predisposition. When previous generations of a person did not exert self-control in their life-time, their genetic makeup will be passed on to him, resulting in a weak wiring of self control in his brain. Additionally lack of self control may be caused by environmental factors, such that if a child's behavior was not monitored, or deviant behavior was not corrected, the child will grow up into a person who lacks self control. On the other hand, higher supervision and too much of punishment can also affect the development of self-control in the child.

Understanding what makes people who they are has been a challenge in the world of psychology. One of the approaches used for determining the personality of a person is by way of taking a psychology based personality test. In such a test, the person answers a set of questions, and based on the answers gets a report detailing the type of personality that person may have. On the other hand, behavior of a person may be observed to determine weak personality traits in him. Behavior of a person who lacks self control may include preferring smaller, immediate rewards over larger but delayed rewards, acting impulsively without much thought and based on what they are feeling at the moment and acting without thinking of the consequences, even if they are potentially damaging, among others.

Negative or weak traits in a person can lead to difficulty in achieving their life goals. Conventionally, people try to overcome their weaknesses when one understands one's weaknesses or weak traits. An individual may approach a counselor or a psychologist with a view that, the counselor or the psychologist may be able to help him address his negative or weak trait. The person may have to undergo several sessions with the counselor. Such sessions may deal with the negative trait via a broad based general (not focused at the root of the weak trait) approach, which may be effective in the short run. For example, if a person is trying to deal with stress, the person may be advised to engage in regular exercise, outdoor games, engage socially and so on, which may prove effective to an extent for the time being.

Currently, there are multiple games and applications that may work in the same way as a counseling process. Even these games deal with the negative trait via a general approach. As an example if a person is not capable of reading at good speed, the person is subjected to games related to reading to improve his speed of reading. Such approach may be effective in the short run and does not address negative traits in a wholesome manner.

In light of the foregoing discussion there is a need for an improved technique to overcome lack of self control, which can be classified as a weak personality trait based on the goals of the person.

### SUMMARY

An embodiment provides a system for enabling a user to overcome lack of self control and/or develop self control. The system includes an activity module. The activity module is configured to enable the user to engage in at least a first activity in a virtual environment. The first activity is directed to rewire a first defective wiring of the brain. The first defective wiring results in a tendency to be biased towards short-term gratification. The activity module is further configured to enable the user to engage in at least a second activity in the virtual environment. The second activity is directed to rewire a second defective wiring of the brain. The second defective wiring results in failure to weigh between short-term gratification and long term outcome. Symptom of the first and the second defective brain wrings is lack of self-control. Additionally, the activity module is configured to provide automated instructions to the user to engage in at least one activity, wherein the one activity is performed in a real world environment. The activity is directed to rewire the first defective wiring of the brain. Furthermore, the activity module is configured to provide automated instructions to the user to engage in yet another activity. The yet another activity is performed in the real world environment. The yet another activity is directed to rewire the second defective wiring of the brain.

Another embodiment provides a method for enabling a user to overcome lack of self-control. The method includes enabling the user to engage in at least a first activity in a virtual environment. The first activity is directed to rewire a first defective wiring of the brain. The first defective wiring results in a tendency to be biased towards short term gratification. The user is enabled to engage in at least a second activity in the virtual environment. The second activity is directed to rewire a second defective wiring of the brain. The second defective wiring results in failure weigh between short term gratification and long term outcome. Symptom of the first and the second defective wiring is lack of self control. Further, automated instructions are provided to the user to engage in at least one activity. The one activity is performed in a real world environment. The activity is directed to rewire the first defective wiring of the brain. Furthermore, automated instructions are provided to the user to engage in yet another activity. The yet another activity is performed in the real world environment. The yet another activity is directed to rewire the second defective wiring of the brain.

Yet another embodiment provides a system for enabling a user to overcome lack of self control. The system includes an activity module configured to enable the user to engage in at least a first activity in a virtual environment, wherein the first activity is directed to rewire a first defective wiring of the brain, wherein the first defective wiring results in tendency to be biased towards short term gratification. The activity module is further configured to enable the user to engage in at least a second activity in the virtual environment, wherein the second activity is directed to rewire a second defective wiring of the brain, wherein the second defective wiring results in failure weigh between short term gratification and long term outcome, wherein symptom of the first and the second defective wiring is lack of self control, wherein engagement in the second activity is enabled after the user has at least participated in the first activity.

### BRIEF DESCRIPTION OF THE DRAWINGS

Embodiments are illustrated by way of example and not limitation in the Figures of the accompanying drawings, in which like references indicate similar elements and in which:

FIG. 1 is an exemplary architecture of an exemplary system 100 to overcome lack of self control;

FIG. 2 is a block diagram of an exemplary activity module 200 to overcome lack of self control;

FIG. 2A is a block diagram of an exemplary behavioral traits database 202 of the activity module 200 to overcome lack of self control;

FIG. 2B is a block diagram of an exemplary collection of games 204 present in the activity module 200 to overcome lack of self control;

FIG. 2C is a block diagram of an exemplary actions database 206 of the activity module 200 to overcome lack of self control; and

FIG. 3 illustrates a flowchart of an exemplary method for overcoming lack of self control.

### DETAILED DESCRIPTION

I. OVERVIEW
II. PRINCIPLE
III. SYSTEM ARCHITECTURE
IV. MODULES OF SYSTEM TO OVERCOME LACK OF SELF CONTROL
V. METHOD FOR OVERCOMING LACK OF SELF CONTROL

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a technical solution to overcome lack of self control, which is a weak behavioral trait. The solution is based on a principle that genetic and environmental factors (may be referred to as “cause”) cause defects in human brain wiring (may be referred to as “defect”), and such defects in human brain wiring express themselves in the form of lack of self control (may be referred to as “symptoms”); hence, to overcome lack of self control, the defective brain wiring have to be rewired, thereby providing a wholesome and long term solution to weak behavioral traits.

In an embodiment, a system is provided to overcome lack of self control/develop self control. The system may include an activity module. The activity module may be configured to enable the user to engage in activities in a virtual environment. The activities in the virtual environment facilitate rewiring of defective brain wiring, wherein the symptom of the defective brain wiring is lack of self control. The activity module may be further configured to provide automated instructions to gradually expose the user to situations in a real environment. The situations may be generally uncomfortable to the user as a result of the defective brain wiring. Exposure to such situation facilitates rewiring of the defective brain wiring.

The activity in the virtual environment may be a brain game. There may be a plurality of levels in the brain game. Each level in the game may have to be successfully completed by the user to unlock a subsequent higher level in the game.

The real world activity may take place in the real world environment, subsequent to the brain games. There may be a plurality of levels in the real world activity.

### II. Principle

Self-control is the capacity to overcome automatic impulses in favor of long term goals. Lack of self control leads to being impulsive about short term goals rather than long term goals. People with low self-control prefer smaller, immediate rewards over larger but delayed rewards. As a result, they act impulsively, without much thought and based on what they are feeling at the moment and acting without thinking of the consequences, even if they are potentially damaging.

Lack of self-control is in fact a symptom or consequence of the way an individual's brain is wired. The way an individual's brain is wired is based on the joint influence of genetic and environmental factors. With regards to each kind of brain wiring, genetic and environmental factors may work together in different proportions.

With regards to lack of self-control, the brain of the person lacking self control is wired such that the person tends to be biased towards short term gratification, which may be a defective brain wiring. Additionally, the brain of the person lacking self control is wired such that the individual do not weigh between short term gratification and long term outcome, which may be considered as another defective brain wiring. Such defective brain wiring may have been caused by one or more of genetic predisposition such as, for example, if the previous generations of a person did not exert self-control in their life-time, their genetic makeup will be passed on to him, resulting in a weak wiring of self control in his brain. Additionally defective brain wiring may have been caused by environmental factors. For example, if a child's behavior was not monitored, or deviant behavior was not corrected, the child will grow up into a person who lacks self control. On the other hand, higher supervision and too much of punishment can also affect the development of self-control in the child.

Embodiments provide a solution to rewire the defective brain wirings (addressing the defect) rather than just addressing the behavioral trait (symptom) without addressing the core defect. The solution is directed towards rewiring the defective brain wirings such that the ability to notice the benefits of the long term outcome is increased and ability to weigh between short term gratification and long term outcome is increased.

It is important to identify the brain wiring that results in development of a trait. A wholesome approach to overcome or eradicate or alleviate a negative or a weak behavioral trait in a person would be to implement ways to rectify defect in the brain wiring.

Brain wirings may be referred to as connections of neural pathways in the brain. These connections of the brain form beliefs, thought patterns and response patterns to external stimulation. Rewiring may be referred to as a process of creating new brain wiring and stimulating a person's existing brain wirings so that his beliefs, thought patterns and responses to external stimulation change for the better.

Individuals lacking self control tend to be biased towards short term gratification and they do not weigh between short term gratification and long term outcome. Different brain regions and neural network of the individual are responsible for such defects. Sensory Stimuli, Thalamus, Visual Cortex, Anterior Insular Cortex, Prefrontal Cortex, Ventral Striatum, Behavioral Activation System, Behavioral Inhibition System, Inferior Frontal Gyms and Motor area, among others are important brain regions or the blocks. When a person does not inhibit temptations in their early life, the Behavioral Inhibition System (BIS) becomes weaker and the Behavioral Activation System (BAS) becomes stronger. Moreover, not having processed the information about the temptation and decision making results in a weaker connection between left AIC and PFC (specifically dorsolateral prefrontal cortex).

### III. System Architecture

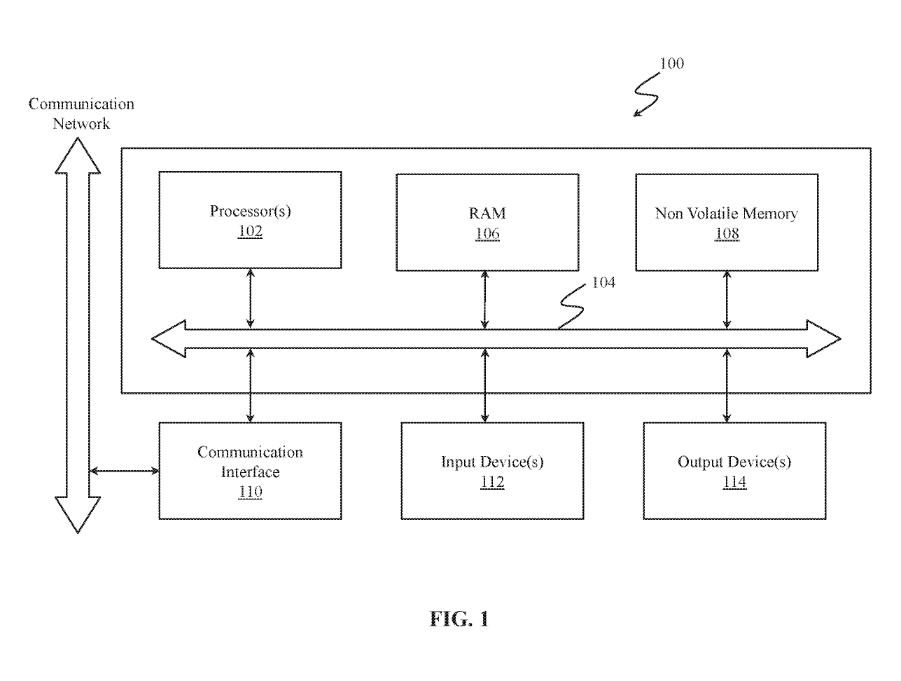

Referring to the figures, more particularly to FIG. 1, an exemplary architecture of an exemplary system 100 to overcome lack of self control/develop self control is provided. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input. In one embodiment, processors 102 may include one or more processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

### IV. Modules of System to Overcome Lack of Self Control

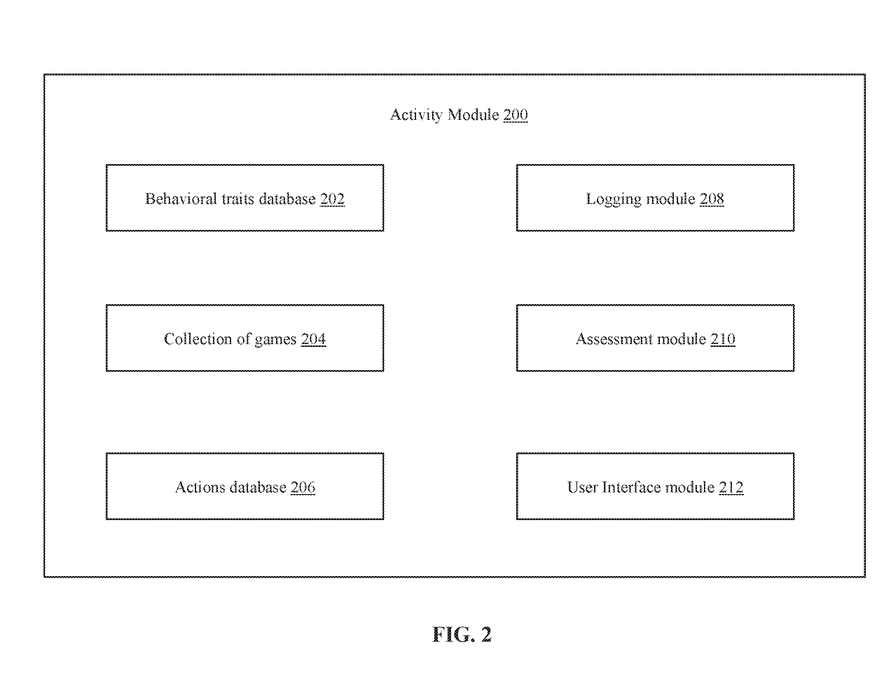

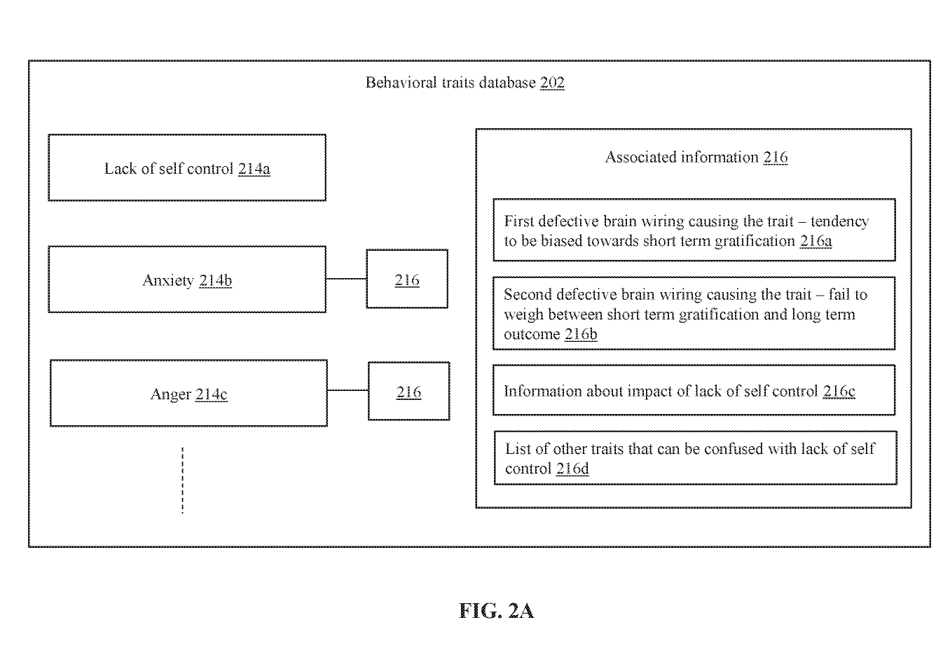

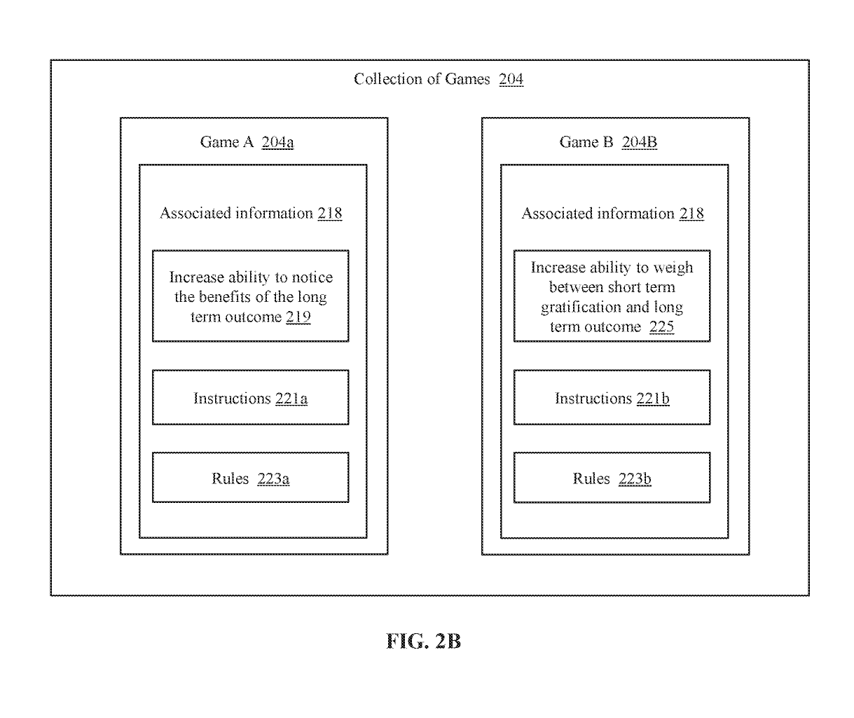

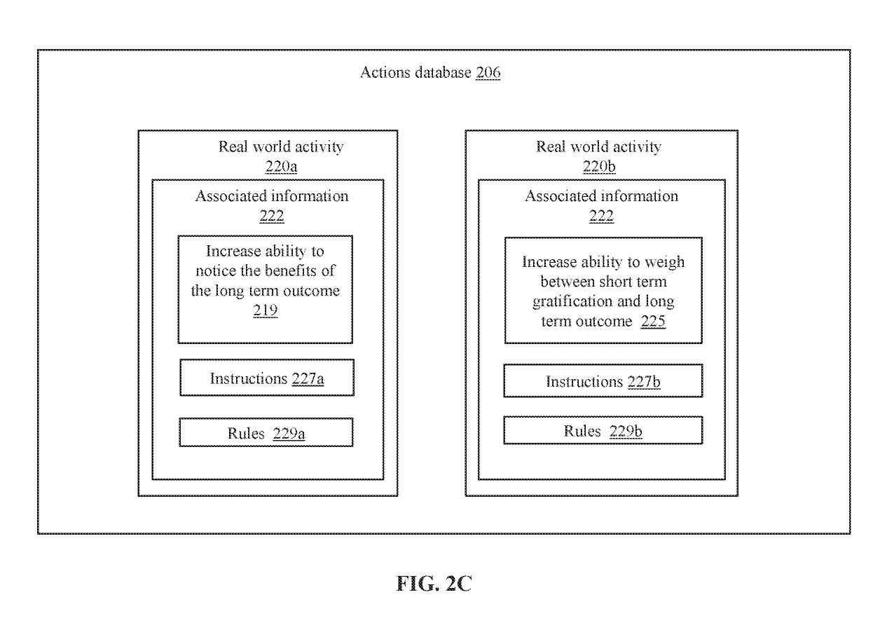

Referring to the figures, and more particularly to FIG. 2, the system 100 includes various modules for enabling users to overcome lack of self control/develop self control. The system 100 includes an activity module 200. The activity module 200 may be a gaming module or an application module. The activity module 200 may be hosted by a communication device that enables a user to play games. Examples of such communication devices may include smart phone, tablet, notebook, laptop and desktop computer, among other devices.

The activity module 200 may include a behavioral traits database 202, a collection of games 204, an actions database 206, a logging module 208, an assessment module 210 and a user interface module 212.

### Behavioral Traits Database 202

Referring to FIG. 2A, in an embodiment, the behavioral traits database 202 may include a list of behavioral traits 214. Examples of behavioral traits 214 include, but not limited to, lack of self control 214a, anxiety 214b and anger 214c, among others. The traits database 202 may further include, with respect to one or more of the behavioral traits, information associated 216 with the trait 214.

With regards to self control/lack of self control 214a, the associated information 216 may include information corresponding to the defective brain wirings (defects) 216a and 216b causing lack of self control 214a (symptom of the defect), information about impact 216c of lack of self control 214a on a person, and a list 216d comprising one or more traits that may be confused with lack of self control 214a, among other information. Some or all of the associated information 216 may be displayed to the user of the activity module 200.

A first defective brain wiring 216a causing lack of self control 214a is the brain wiring causing an individual to be biased towards short term gratification. A second defective brain wiring 216b causing lack of self control 214a is the brain wiring causing an individual to fail to weigh between short term gratification and long term outcome.

In an embodiment, the information corresponding to the first and second defective brain wiring 216a, 216b causing lack of self control 214a enables the activity module 200 to select games, activities or actions to overcome lack of self control 214a or in other words, develop self control.

In an embodiment, displaying the information corresponding to the defective brain wiring (defect) 216a, 216b causing lack of self control 214a helps the user in understanding the defects responsible for lack of self control 214a, thereby motivating the user to follow the instructions provided by the activity module 200.

Information about impact 216c of lack of self control 214a can include one or more of preferring smaller, immediate rewards over larger but delayed rewards. Acting impulsively without much thought and based on what they are feeling at the moment and acting without thinking of the consequences, even if they are potentially damaging.

The list 216d of other traits that can be confused with lack of self control 214a includes anger and impatience among others.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome lack of self control 214a and develop the quality of self control.

With regards to lack of self control 214a, the brain rewiring attempted to achieve to overcome lack of self control 214a includes rewiring the defective brain wirings 216a, 216b such that ability to notice the benefits of the long term outcome is increased and ability to weigh between short term gratification and long term outcome is increased.

In an embodiment, the activity module 200 may display the information corresponding to the causes (genetic or environmental) that resulted in the defective brain wirings (defect) 216a, 216b, which in turn resulted in lack of self control 214a, thereby enabling the user to relate to the cause, defect and symptom of the defect, which results in a wholesome experience while working to overcome lack of self control 214a.

Collection of games 204

The activity module 200 includes a collection of digital games 204, which are played in a virtual world. Each of the games 204 is used by the activity module 200 based on the brain rewiring, which the game 204 is capable of achieving.

Referring to FIG. 2B, in an embodiment, each game 204a-204b (may be referred to as game 204 or games 204) may include associated information 218. As an example, a game may be capable of achieving more than one type of brain rewiring. Alternatively, one single type of rewiring may be achieved through more than one game. Each game 204 includes data indicating the brain rewiring(s) 219, 225 it is capable of achieving, so that the activity module 200 can opt to present a choice of one or more games, which has the capability to achieve the brain rewiring, which the activity module 200 is attempting to achieve.

The associated information 218 may further include instructions 221 to be followed by the user to play the game 204. The associated information 218 may additionally include one or more rules 223. Examples of rules include rules for playing each game, rules to proceed to a higher level, scoring method in each level and time assigned to each level to reach the end of the level, among others.

In an embodiment, a higher level of the digital game 204 is unlocked based on predefined criteria.

In an embodiment, the higher level is unlocked upon repeatedly playing a previous level in the digital game 204 for a predefined number of times or duration of time.

In the example presented in FIG. 2B, games 204a-204b are included in the collection of games 204. The games 204a-204b can be used by the activity module 200 to correct the defective brain wirings 216a and 216b by rewiring the brain to increase the ability to notice the benefits of the long term outcome 219 and increase ability to weigh between short term gratification and long term outcome 225.

In an embodiment, and as an example, Game A 204a may be directed at rewiring 219 the brain to increase the ability to notice the benefits of the long term outcome. Game B 204 b may be directed at rewiring 225 the brain to increase the ability to weigh between short term gratification and long term outcome.

Game A 204a may be designed to enable them to notice the benefits of the long term outcome. 219. The instruction 221a may include recommendation to play the game 204a for at least a predefined duration for a predefined number of days. The rules 223a may allow proceeding to a next level in the game 204a once a desired level of performance is achieved.

In Game A 204a, the user will be presented a situation which tempts the user to lose self control. The user will be given a plurality of options. The user has to choose the option which makes the individual favor the long-term outcome over short-term gratification. An example of a situation is presented below with all the options. In a real game only a subset of the options are shown.

### Situation:

“You are an intelligent student, who aspires to shape up your career. To reach your career goals, you joined a certificate course. You have come across a skill development training workshop that sounds really cool.”

### Long-Term Outcome

Being an academic course, the certificate program will be considered for your graduation.
Employers and institutions give more weightage to certificate courses.
This certificate course will look great on your resume.
Academic collaboration and networking with people of your field, promise opportunities during the certificate program.
Certificate program is highly advanced.
Your learning will be put to test during the certificate program.
The grades of certificate program will add up to your GPA.
You'll receive individual attention during the certificate program.
The long time stretch that the certificate program is spread over, will help in absorbing knowledge.
The certificate program is worth the money.

### Short-Term Gratification

There is a lot of interesting practical application during the workshop.
A workshop will be short and sweet.
When it comes to workshop, you will enjoy great flexibility in timings and sessions.
Many of your friends are going to be attending the workshop. So it sounds like fun.
You will learn a lot more in a short span of time during a workshop.
The place where the workshop is going to be conducted is very near by.
The workshop costs lesser.
This workshop is going to be intense and fast.
The enrollment and paperwork for the workshop is much simpler and easier.
Certain specific topics that you are interested in, are going to be covered in the workshop.

Game B 204b may be designed to enhance one's ability to weigh between short term gratification and long term outcome 225. The instruction 221b may include recommendation to play the game 204b for at least a predefined duration for a predefined number of days, for example, 3 times a day. The rules 223b may allow proceeding to a next level in the game 204b once a desired level of performance is achieved. Game B 204b may include a plurality of levels.

In a first level, small circles will appear and disappear in every 2-3 seconds interval, on a screen. The circles will have some patterns, such as square, rectangle, triangle, lines, numbers etc. Simultaneously, stars will appear and disappear. For example, when a circle is shown, simultaneously stars will appear and disappear. The user has to make a decision whether to focus on counting the stars or identifying the position of the circles or both. The stars will appear until the circles disappear. Instructions 221b may recommend that 10 such patterns should be shown one after the other. Rules 223b recommends that the user has to identify 7 patterns and count stars 3 times out of 10 stimuli. In this game, stars may be the short term reward and identifying patterns and earning 100 points may be the long term goal. Further, instructions may be provided that the user should be presented with 10 stimuli in this level and the complexity of the task should be 8, as an example.

In a second and a third level, complexity increases in identifying the patterns. Also, the speed of appearing and disappearing of stars will keep varying, within the pattern itself. The user may be presented with 10 stimuli in these levels and the complexity of the tasks should be 8, as an example.

### Actions Database 206

The actions database 206 includes information corresponding to a plurality of real world activities or sets of real world activities. Real world activities may include activities that are performed in a real world environment, as opposed to the digital games played in the virtual world (ex: games included in the collection of games 204).

Referring to FIG. 2C, each of the real world activities 220a-220b (may be referred by numeral 220) or sets of real world activities 220a-220b (may be referred by numeral 220) is used by the activity module 200 based on the brain rewiring 219, 225, which the real world activity 220 is capable of achieving.

Each real world activity 220 may include associated information 222. As an example, a real world activity may be capable of achieving more than one type of brain rewiring. Each real world activity 220 includes data indicating the brain rewiring(s) 219, 225 it is capable of achieving, so that the activity module 200 can opt to present a choice of one or more real world activities 220, which has the capability to achieve the brain rewiring, which the activity module 200 is attempting to achieve.

The associated information 222 may further include instructions 227 to be followed by the user to perform the real world activity 220 or a set of real world activities 220. The associated information 222 may additionally include one or more rules 229. Examples of rules include rules to proceed to a higher level, scoring method in each level and time assigned to each level to reach the end of the level, among others.

The real world activity 220a may be presented to the user after the user has at least participated in one or more games to a predefined extent that attempts to rewire 219 the first defective brain wiring 216a. The real world activity 220a may be designed to rewire the brain to increase the ability to notice the benefits of the long term outcome 219. Instructions 227a may include recommendation that the action has to be carried out every day and rules 229a may state that each level has to be repeated 5 times, before the next level unlocks.

The user may be recommended to select a situation in which the user tends to lose self control. The activity module 200 may be configured to show the category and its respective actions. The situations presented by the activity module in which the user tend to lose self control may include:
Overeating
Over Spending
Net Surfing

The real world activity 220a may include a plurality of levels. In a first level, the activity module 200 chooses the situations sequentially and displays it to the user.

### 1. Over Eating

Choose a quiet place to sit in. Close your eyes and imagine in detail what is shown to you below. Think of your favorite junk food (like, potato chips, soft drinks, etc) that you like to have. Now, think of a long term benefit not to have the food.
Choose a quiet place to sit in. Close your eyes and imagine in detail what is shown to you below. Imagine that you are home alone. You've been so “good” all week, eating your steamed vegetables and low fat desserts. However, your spouse/roommate/friends have brought home your favorite desserts (like, ice cream, cake, chocolates, etc) and it's staring right at you. Now, think of a long term benefit to withdraw you from eating the food based on your long term goal. Write it down in your journal or a piece of paper.
Imagine this scenario after having a sumptuous dinner/lunch and relaxing in your couch. Imagine your neighbor baking cookies and the smell fills the whole living room. This made you to remember the half a box of cookies lying in the refrigerator. Now, think of a long term benefit to withdraw you from eating the cookies based on your long term goal. Write it down in your journal or a piece of paper.
Choose a quiet place to sit in. Close your eyes and imagine in detail what is shown to you below. Imagine during the snack break, your colleague's/friends are buying some carb food (like, burger, potato chips, burrito, etc) and offering you. You tell them politely that you already have good lunch, so there is no need of having more carb.
Choose a meal where you tend to eat more food (lunch or dinner). Choose a smaller plate to eat. Take 15-20 minutes, chew the food slowly, have little water in between having the food. After having food, surf the benefit of eating the food that you had. Write down or reflect whether it is good to eat the food for the benefit of your long term goal.
Long Term Goal:
To lose weight and eat healthy food
Long Term Benefit:
It will help me to remain healthy in future.
My skin will look younger, if I withdraw myself from junk food.
It will help me to lose weight quicker and maintain my weight.
Eating more carbohydrate for a day will not help to lose weight.

### 2. Over Spending

Choose a quiet place to sit in. Close your eyes and imagine in detail what is shown to you below.
Imagine after working hard from morning you are feeling hungry and wanted to have food at a restaurant. The food looks amazing and delicious, on the other hand think of homemade food, which also looks amazing, delicious, healthy and it helping you to save more money at the end of the month.
Imagine you are going to a shopping mall. Your budget of the month to buy clothe is $30/Rs 800, but you like clothe which is expensive and doesn't fit into your budget. Imagine that you are trying to find clothe that best suit your budget and stepping out the mall happily.
Imagine your friends are calling you for a night out. Think of the amount of money you have spent in the party for the past few weeks. Imagine that saving money now by not going to the party will help you to save money for some emergency expenses.
Imagine you are going to a shopping mall. Your budget of the month to buy clothe is $30/Rs 800, but you like clothe which is expensive and doesn't fit into your budget. Imagine that you are trying to step out of the shop and going into another shop to find clothe that best suit your budget and stepping out the mall happily.
Imagine your friends are calling for the long week end out. Think of the amount of money you have spent just for fun or entertainment. Imagine that saving money now by not going to the week end out will help you to save money for vital expenses at the end of the month.
Imagine you are going to a shopping mall. Your budget of the month to buy clothe is $30/Rs 800, but you like clothe which is expensive and doesn't fit into your budget. Imagine the consequences of spending more money in the present and totally getting dried out at the end of the month.
Imagine your friend have bought a new car/bike. You liked it very much, when your friend offered you ride it. You are tempted to buy it immediately. Imagine the consequences of spending money on vehicle when you already have one.

### 3. Net Surfing

Imagine your boss have assigned you an important work. You are in the urge of completely your profit. Sometime you hear a notification from social network site in your mobile. Since you wanted to finish your work you did not open the social network.
Imagine you have gone to office early. Since nobody is around, you are using social networking site. After 10 minutes, you are closing the website and starting your work.
Imagine you have an upcoming exam, you are studying for couple of hours and then for 5 minutes you are net surfing and then you are going back to the studies.
Imagine you are driving to your office, You are getting a notification in a social networking site in your mobile. You are ignoring the message, because your driving. After reaching the office you are opening the notification and respond to it and closing it immediately.
Imagine you are in a classroom listening to a lecture. You got a notification in a social networking site from your mobile. You take the mobile out put them in silence. After the lecture is over, you open the notification and respond it and closing it immediately.

In a second level, the tasks will be mentioned and each task belonging to a category that the user selected will be shown sequentially.
Screen 1:

### 1. Over Eating

Think of your favorite snack. During the snack time, buy the snack and eat half of the portion and give away the other half of the portion to your friend/colleague or save the rest for later. While eating the snack, close your eyes, chew the food, taste the food, and think of the long term benefit of not eating the food.
When you go to lunch/dinner, decide in prior what you want to eat and order the quantity lesser than what you usually have. While eating the food, close your eyes, chew the food, taste the food, and think of the long term benefit of not eating the food.
During the snack break, if you usually have two junk food. Replace one item with a healthy food. (Example, if you have a cup of coffee and potato chips. Replace potato chips with steamed corn). While eating the food, close your eyes, chew the food, taste the food, and think of the long term benefit of not eating the food.
When you go to your favorite restaurant to eat, replace one carb food with a healthy food. (Example, if you like to order a burger and French dip. Replace one carb with soup or a healthy appetizer).While eating the food, close your eyes, chew the food, taste the food, and think of the long term benefit of not eating the food.

### 2. Over Spending

You go to your favorite shop for shopping. Cut down your spending cost by 30%. You shall go for shopping twice a week.
   Spending amount: show amount from $ 30, 50, 70, 100, 150, 170, 200, 220, 250, 270, 300, 320, 350, 370, 400, 420, 450, 470, 500
   Amount of money to be spent: calculate 30% of the amount user is selecting and it has to be shown in a box
You go to your favorite pub. Cut down your spending cost by 30%.
You shall go to pub twice a week.
   Spending amount: show amount from $ 30, 50. 70, 100, 150, 170, 200, 220, 250, 270, 300, 320, 350, 370, 400, 420, 450, 470, 500
   Amount of money to be spent: calculate 30% of the amount user is selecting and it has to be shown in a box
If you are a person spend money on watching movies, then you go to theater to watch film twice a week.
If you are a person spend money by eating outside. Try to go to the restaurant twice a week.

### 3. Net Surfing

Try to cut down your surfing time by 30% lesser.

Time Spending on Surfing: 3 hrs, 4, 5, 6, 7, 8, 9, 10, 11, 12
Amount of time should be spent every day: calculate 30% of the time from user is selecting and it has to be shown in the box.

In a third level, the tasks will be mentioned and each task belonging to a category that the user selected will be shown sequentially.

### 1. Overeating

When your friends invited to have dinner, politely tell them that you are in diet, so you would like to have light meal, and ask them to check on you if you tend to over eat.

### 2. Over Spending

You go to your favorite shop for shopping. Cut down your spending cost by 50%. You shall go for shopping once a week.
   Spending amount: show amount from $ 30, 50. 70, 100, 150, 170, 200, 220, 250, 270, 300, 320, 350, 370, 400, 420, 450, 470, 500
   Amount of money to be spent: calculate 50% of the amount user is selecting and it has to be shown in a box.
You go to your favorite pub. Cut down your spending cost by 50%. You shall go to pub once a week.
   Spending amount: show amount from $ 30, 50. 70, 100, 150, 170, 200, 220, 250, 270, 300, 320, 350, 370, 400, 420, 450, 470, 500
   Amount of money to be spent: calculate 50% of the amount user is selecting and it has to be shown in a box.
If you are person spend money on watching movie, and then you go to theater to watch film once a week.
If you are a person spend money by eating outside. Try to go to the restaurant once a week.

### 3. Net Surfing

Try to cut down your surfing time by 50% lesser.
   Time Spending on Surfing: 3 hrs, 4, 5, 6, 7, 8, 9, 10, 11, 1
   Amount of time should be spent every day: calculate 30% of the time from user is selecting and it has to be shown in the box.

In a fourth level, the tasks will be mentioned and each task belonging to a category that the user selected will be shown sequentially.

### 1. Overeating

Go to your favorite restaurant along with your friend/spouse and stay there for a while. Let the aroma goes into your being. Abstain from ordering your favorite high calorie food. Instead, order a healthy food that has low calorie.

### 2. Over Spending

You go to your favorite shop for shopping. Cut down your spending cost by 75%. You shall go for shopping once a week.
   Spending amount: show amount from $ 30, 50. 70, 100, 150, 170, 200, 220, 250, 270, 300, 320, 350, 370, 400, 420, 450, 470, 500
   Amount of money to be spent: calculate 75% of the amount user is selecting and it has to be shown in a box
You go to your favorite pub. Cut down your spending cost by 75%. You shall go to pub once a week.
Spending amount: show amount from $ 30, 50. 70, 100, 150, 170, 200, 220, 250, 270, 300, 320, 350, 370, 400, 420, 450, 470, 500
   Amount of money to be spent: calculate 75% of the amount user is selecting and it has to be shown in a box
If you are person spend money on watching movie, then you go to theater to watch film once in 2 weeks.
If you are a person spend money by eating outside. Try to go to the restaurant once in 2

weeks.

### 3. Net Surfing

Try to cut down your surfing time by 75% lesser.
   Time Spending on Surfing: 3 hrs, 4, 5, 6, 7, 8, 9, 10, 11, 12
   Amount of time should be spent every day: calculate 75% of the time from user is selecting and it has to be shown in the box.

The real world activity 220b may be presented to the user after the user has at least participated in one or more games to a predefined extent that attempts to rewire 225 the first defective brain wiring 216b. The real world activity 220b may be designed to rewire the brain to increase the ability to weigh between short-term gratification and long-term outcome 225. Instructions 227b may include recommendation that the action has to be carried out every day and rules 229b may state that each level has to be repeated for a predefined number of times, before the next level unlocks.

Real world activity 220b may include a plurality of levels. In a first level, the tasks will be mentioned and each task belonging to a category that the user selected will be shown sequentially.
Screen 1:

### 1. Overeating

Imagine you are on diet schedule for a month. Imagine your colleague have brought cake and distributing to your other colleagues. Soon your turn will come. Imagine the smell, aroma, and flavor of the cake communicating with your mind and making you to eat the cake. Then, think how eating this cake will affect your diet plan. Later imagine that your taking only a small piece of cake instead of the big one, which your colleague trying to offer you.

### 2. Over Spending

Imagine your colleague have bought a new shoe and showed it to you. You liked it very much, and it will also look good on you. You are tempted to buy the shoe. Now think of the reason why you wanted to buy the shoe. Is it because you liked it, or you did not have a shoe to wear. Then think of your budget list of the month. If you already have a shoe and buying shoes is not the priority, imagine that you will buy the shoe once the need comes. If you do not have a shoe and you wanted to buy it, remove one item from your budget list and think of buying the shoe.

### 3. Net Surfing

Imagine your boss have sent some important mail through your personal email, as there was a problem in your official email. While opening your email account, you come across an advertisement that has exciting offers. You wanted to click on it. Now think of the excitement and good offers that you may come across. Then, you think of the importance of reading the email. The tasks you might have to complete before the end of the day. Now imagine you are neglecting the advertisement and concentrating on reading the email.
Screen 2:
By imagining you will be mentally prepared on how to deal with situations where you need some emotional strength.

In a second level, the tasks will be mentioned and each task belonging to a category that the user selected will be shown sequentially.

### 1. Overeating

When you lose self control in eating junk food. Take a paper immediately and write down the pleasure of eating the food and the need for abstaining from eating the junk food. Come up with at least 6-10 facts.

### Example:

Pleasure of eating the food
The food looks delicious
The food smells good
The aroma of the food entering my body
The food makes me mouth watering
Abstaining from not eating the food
It is not good for my health
It will add up bad fat in my body
I will gain weight
This will become a habit in future

### 2. Over Spending

When you lose self control in spending money on buying clothes, accessories or going to a restaurant. Take a paper immediately and write down the pleasure of going for a shopping and the importance of saving money. Come up with at least 6-10 facts.

### Example

Pleasure of buying clothes
It is very exciting to go for shopping to buy clothes
I don't have a dress in that style
The dress is on sale, so I will not get this opportunity in future
I will look good on that dress
Importance of saving money
I might need money for emergency expenses
It is important to invest money for tax saving
Medical expenses can occur at any time for me or for my family

### 3. Net Surfing

When you lose self control for using social networking site or surfing, immediately take a paper and write down the urge of using social networking site or surfing and the importance of abstaining yourself from using social networking site or surfing

### Example

Urge of using social networking site
My friends might have commented for the photo that I uploaded few hours back
It might be the girl/boy who met the other day might have accepted my friend request
All my friends might be chatting
Importance of abstaining myself from social networking site
I have a deadline to complete my project
I can utilize this time effectively to refresh my mind by talking with my colleague or listening to a good music
I shall use social networking site after work

In a third level, the tasks will be mentioned and each task belonging to a category that the user selected will be shown sequentially.

### 1. Overeating

During the first day of the week, if we tend to lose your self control in eating junk food or over eating, try to abstain yourself not to eat. The next day treat yourself by eating what you are tempted to eat the other day. Practice this for every alternative days.

### 2. Overspending

During the first day of the week, if you tend to lose your self control in shopping, go to your favorite online shopping website and choose what you like and abstain yourself not buying it. The next day buy the 50% of the clothes that you have it in your shopping cart. Practice this for every alternative days.

### 3. Net Surfing

During the first day of the week, if you tend to lose self control in surfing, abstain yourself not surfing social networking site. The next day treat yourself by surfing the social networking site. Practice this for every alternative day.

In a fourth level, the tasks will be mentioned and each task belonging to a category that the user selected will be shown sequentially.
Screen 1:

### 1. Overeating

During the first four days of the week, if we tend to lose your self control in eating junk food or over eating, try to abstain yourself not to eat. The other three days in a week treat yourself by eating what you are tempted to eat the other day. Practice this every week.

### 2. Overspending

During the first day of the week, if you tend to lose your self control in shopping, go to your favorite online shopping website and choose what you like and abstain yourself not buying it. The next day buy the 30% of the clothes that you have it in your shopping cart. Practice this for every alternative days.

### 3. Net Surfing

During the first four days of the week, if you tend to lose self control in surfing, abstain yourself not surfing social networking site. The other three days treat yourself by surfing. However, you shall surf only 30 minutes each day. Practice this every week.

In a fifth level, instructions will be provided on a screen to mentor another individual who have low self control (and who wants to change) and guide them on the skills that you have learned. This person could be your friend/family member or colleague.

In an embodiment, the action database 206 further includes plurality of physical actions, mind actions and dietary actions, one or more of which may be presented to a user who is trying to overcome lack of self control 214a.

Example of physical actions includes one or more physical activities, such as exercises and physical postures, among others. Example of mind actions may include meditation. Example of dietary actions may include adding specific food to one's diet or deleting specific food from the diet. As a further example, drinking black tea may be a dietary action and cutting down on rice consumption may be another dietary action.

### Logging Module 208

In an embodiment, the logging module 208 enables logging of the activities (ex: games, real world activities and other actions) performed by the user. The logging module 208 may record information corresponding to the activities performed by the user. The information may include one or more of, time of performance, date of performance, quantum of performance, success or failure consequent to an attempt to perform, and extent of success in performing the action, among others. The user may provide input that an activity has been performed. Such input may be used to log the activity in the logging module 208. Alternatively, the logging module 208 may be configured to automatically log the performance of an activity upon detection that the activity has been performed.

### Assessment Module 210

The assessment module 210 of the activity module 200 is configured to determine the performance of a user in each activity the user performs. The assessment module 210 may determine the user's score for each game and at each level in a game based on the log available in the logging module 208. Further, the assessment module 210 analyzes performance of the user in the real world activities and determines scores of each level of real world activity based on the log that is present in the logging module 208. The assessment module 210 may also determine status of the one or more behavioral trait 214 or the brain wiring causing the trait, after engaging in the activities, based on performance of activities suggested by the activity module 200.

### User Interface Module 212

The user interface module 212 may be configured to receive input from the user and display content to the user. The content displayed, can be, as an example, games, images, instructions, rules, information, haptic feedback and sound, among others.

### V. Method for Overcoming Lack of Self Control

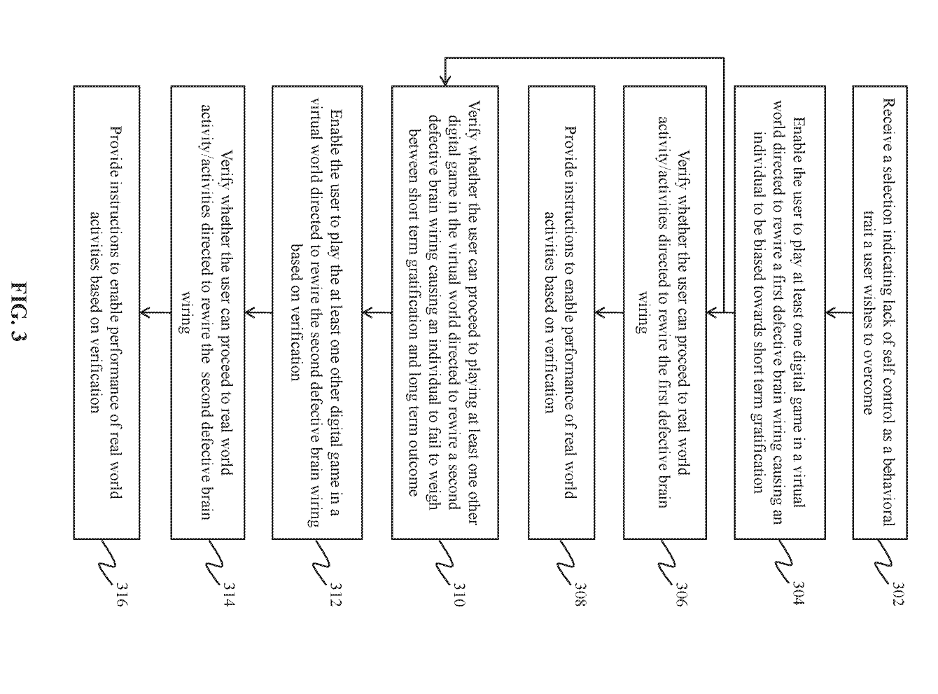

Now referring more particularly to FIG. 3, a method is provided for overcoming lack of self control 214a. A selection indicating lack of self control 214a as a behavioral trait which a user wishes to overcome is received at step 302. At step 304, a user is enabled to participate in/play at least one digital game 204a, which is played in a virtual world. The digital game 204a is instrumental in rewiring 219 a first defective brain wiring 216a, whose symptom is exhibition of lack of self control 214a. At step 306, verification is made to determine whether the user can proceed to perform real world activities 220a. In case it is determined that user can proceed, then at step 308, instructions are provided to the user to enable the user to perform appropriate real world activity/activities 220a. Preferably, the user is allowed to perform or instructed to begin performing appropriate real world activities 220a upon participating in the digital game 204a at least to a predefined extent, which is determined based on the desired rewiring. The real world activity 220a is instrumental in rewiring 219 the first defective brain wiring 216a, whose symptom is exhibition of lack of self control 214a.

At step 310, verification is made to determine whether the user can proceed to playing at least one other digital game 204b in the virtual world directed to rewire a second defective brain wiring 216b. In case it is determined that user can proceed, then at step 312 the user is enabled to participate/play in one or more digital game 204b, which is played in a virtual world. The digital games 204b are instrumental in rewiring 225 the second defective brain wiring 216b, whose symptom is exhibition of lack of self control 214a. Preferably, the user is allowed to proceed to playing the at least one other digital game 204b upon participating in the game(s) instrumental in rewiring 219 the first defective wiring 216a at least to a predefined extent, which is determined based on the desired rewiring.

At step 314, verification is made to determine whether the user can proceed to perform real world activities 220b. In case it is determined that user can proceed, then at step 316, instructions are provided to the user to enable the user to perform appropriate real world activity/activities 220b. Preferably, the user is allowed to perform or instructed to begin performing appropriate real world activities 220b upon participating in the digital game(s) 204b at least to a predefined extent, which is determined based on the desired rewiring. The real world activity 220b are instrumental in rewiring 225 the second defective brain wiring 216b, whose symptom is exhibition of lack of self control 214a.

Referring to the step (302) of receiving a selection indicating lack of self control 214a, the user may be provided an option to select a behavioral trait that he would like to overcome. The activity module 200 may provide or recommend an option to select at least one weak behavioral trait to work on. The user may select at least one behavioral trait 214 that the user thinks he needs to work on, from a list of behavioral traits that may be displayed to the user via the user interface module 212. Alternatively, the user may input answers in response to a set of questions displayed to the user, which may determine what type of weak behavioral trait 214 the user may have. Upon selection of lack of self control 214a, the activity module 200 may display a list 216d of other behavioral traits that can be confused with lack of self control 214a, so that the user can select a more appropriate behavioral trait 214, which he desires to work on. The activity module 200 may further display the information corresponding to the brain wirings (defect) 216a, 216b causing the behavioral trait 214. The first defective brain wiring 216a causes the individual to be biased towards short term gratification. The second defective brain wiring 216b causes an individual to fail to weigh between short term gratification and long term outcome.

The activity module 200 may additionally display information about impact 216c of lack of self control 214a to the user. In addition, the activity module 200 may display information corresponding to the brain rewiring 219, 225 that the activity module 200 is attempting to achieve to overcome lack of self control 214a. Rewiring 219 of the first defective brain wiring 216a results in increased ability to notice the benefits of the long term outcome. Rewiring 225 of the second defective brain wiring 216b results in increased ability to weigh between short term gratification and long term outcome.

Furthermore, the activity module 200 may display the information corresponding to the causes (genetic or environmental) that resulted in the defective brain wirings (defect) 216a, 216b.

Referring to the step (304) of enabling the user to play at least one digital game in the virtual world directed to rewire the first defective brain wiring 216a, the activity module 200 may select one or more digital games based on the capability of the digital games to achieve the desired brain rewiring 219.

The activity module 200 may provide a choice (one or more games) of games, from which the user may select. The activity module 200 may even indicate the effectiveness of each of the games in achieving the desired brain rewiring 219 or an aspect of rewiring.

In an embodiment, the activity module 200 is configured to recommend a plurality of games 204, wherein the recommendation indicates each of the games' 204 effectiveness to achieve the desired brain rewiring 219 or an aspect of rewiring.

The activity module 200 allows the user to play the selected game. The logging module 208 may log the performance of the user. The assessment module 210 may determine the performance scores using the log in the logging module 208. Further, based on the respective rules 223, the user is either allowed or denied access to other levels of the game 204.

Referring to step 306, the activity module 200 verifies whether the user can proceed to perform real world activities 220. Preferably, the activity module 200 recommends real world activities 220 after the user has performed to a desired extent in the digital game(s) 204. Desired extent of performance can be, as an example, levels completed, score reached and duration over which the game 204 was played.

In an embodiment, the activity module 200 recommends participating in real world activity 220a or a part thereof, after the user has performed to a desired extent in the digital game 204a. Desired extent of performance can be, as an example, levels completed, score reached and duration over which the game(s) were played.

In an embodiment, the activity module 200 recommends participating in a level or part of real world activity (ex: level of real world activity 220a) after the user has performed to a desired extent in a level of the digital games (ex: level of digital game 204a), wherein the level of the digital game prepares the user to participate in the level or part of the real world activity.

In an embodiment, the activity module 200 is configured to recommend a plurality of real world activities or sets of real world activities 220, wherein the recommendation indicates each of the real world activities' or sets of real world activities' 220 effectiveness to achieve the desired brain rewiring.

The logging module 208 may log the performance of the user. The assessment module 210 may determine the performance scores using the log in the logging module 208. Further, based on the rules 229, the user is either allowed or denied access to other levels of the real world activities or sets of real world activities.

Referring to step 310, the activity module 200 verifies whether the user can proceed to playing at least one other digital game in the virtual world directed to rewire the second defective brain wiring 216b causing an individual to fail to weigh between short term gratification and long term outcome. Rewiring the second defective brain wiring 216b results in ability to weigh between short term gratification and long term outcome.

In an embodiment, the activity module 200 recommends participating in digital games directed to rewire the second defective brain wiring 216b after the user has performed to a desired extent in the digital game(s) (204b) directed to rewire the first defective brain wiring 216a.

In an embodiment, the activity module 200 recommends participating in digital games directed to rewire the second defective brain wiring 216b after the user has performed to a desired extent in the digital game(s) (204a) and real world activity/activities (220a) directed to rewire the first defective brain wiring 216a.

The activity module 200, based on the verification, enables the user to play/participate in one or more other digital games 204b in the virtual world directed to rewire the second defective brain wiring 216b.

In an embodiment, the activity module 200 recommends participating in real world activity 220a or part thereof after the user has performed to a desired extent in the digital game 204a. Likewise, the activity module 200 recommends participating in real world activity 220b or part thereof after the user has performed to a desired extent in the digital game 204b.

In another embodiment, the activity module 200 recommends participating in digital game 204b after the user has performed to a desired extent in a level of the digital game 204a.

Additionally, the activity module 200 may provide instruction to perform mind actions, physical actions and dietary actions.

Each of the physical and dietary actions may have effect on one or more hormones corresponding to one or more traits, among others. While executing the physical action the energy expended in the body is more compared to the energy expended while playing brain game. Similarly, the mind action may involve thinking about the specific trait in a way which may change the structure of the brain by changing the Axons, Receptors and/or the number of Neurons. The dietary action may include consuming specific foods which changes one or more hormone levels.

The real world, mind, physical and dietary activities are carried out in a real environment. Automated instructions are provided as to when and how the activities may have to be carried out. Further, there may be instructions that one or more of the real world activities may have to be carried out simultaneously with the brain games and one or more of the activities may have to be carried out prior to or after engaging in brain game (digital games) and performing to a desired extent.

In an embodiment, upon selecting lack of self control, the activity module 200 provides a scale operable by the user to select a position on the scale. The position may be indicative of the user's lack of self control. Improvement in lack of self control and development of self control resulting from the rewiring of the brain achieved by the performance of the activities (virtual games or real world activities) enabled by the activity module 200 is reflected on the scale. Degradation of the improvement in self control resulting from the degradation of the rewiring of the brain due to premature halt in performance of the activities (virtual games or real world activities) enabled by the activity module 200 is also reflected on the scale.

The games and the real world activities change the neural connections in the brain. When these activities are carried out repeatedly, new neural connections are formed (brain plasticity) but if one stops carrying out these activities prematurely then slowly the neural connections die.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling a user to overcome lack of self control, the system comprising an activity module configured to:
enable the user to engage in at least a first activity in a virtual environment, wherein the first activity is directed to rewire a first defective wiring of the brain, wherein the first defective wiring results in a tendency to be biased towards short term gratification;
enable the user to engage in at least a second activity in the virtual environment, wherein the second activity is directed to rewire a second defective wiring of the brain, wherein the second defective wiring results in failure to weigh between short term gratification and long term outcome, wherein symptom of the first and the second defective wirings is lack of self control;
provide automated instructions to the user to engage in at least one activity, wherein the one activity is performed in a real world environment, wherein the activity is directed to rewire the first defective wiring of the brain; and
provide automated instructions to the user to engage in yet another activity, wherein the yet another activity is performed in the real world environment, wherein the yet another activity is directed to rewire the second defective wiring of the brain.

2. The system of claim 1, wherein the activities in the virtual environment are digital games.

3. The system of claim 1, wherein the activity module is further configured to provide the automated instructions to engage in the activity directed to rewire the first defective wiring to be performed in the real world environment, after the user has at least participated in the first activity.

4. The system of claim 1, wherein the activity module is further configured to provide the automated instructions to engage in the activity directed to rewire the second defective wiring to be performed in the real world environment, after the user has at least participated in the second activity.

5. The system of claim 1, wherein the activity module is further configured to enable the user to engage in the second activity, after the user has at least participated in the first activity.

6. A method for enabling a user to overcome lack of self control, the method comprising:
enabling the user to engage in at least a first activity in a virtual environment, wherein the first activity is directed to rewire a first defective wiring of the brain, wherein the first defective wiring results in a tendency to be biased towards short term gratification;
enabling the user to engage in at least a second activity in the virtual environment, wherein the second activity is directed to rewire a second defective wiring of the brain, wherein the second defective wiring results in failure to weigh between short term gratification and long term outcome, wherein symptom of the first and the second defective wirings is lack of self control;
providing automated instructions to the user to engage in at least one activity, wherein the one activity is performed in a real world environment, wherein the activity is directed to rewire the first defective wiring of the brain; and
providing automated instructions to the user to engage in yet another activity, wherein the yet another activity is performed in the real world environment, wherein the yet another activity is directed to rewire the second defective wiring of the brain.

7. The method of claim 6, wherein the activities in the virtual environment are digital games.

8. The method of claim 6, wherein the automated instructions to engage in the activity directed to rewire the first defective wiring, to be performed in the real world environment, is provided after the user has at least participated in the first activity.

9. The method of claim 6, wherein the automated instructions to engage in the activity directed to rewire the second defective wirings, to be performed in the real world environment, is provided after the user has at least participated in the second activity.

10. The method of claim 6, wherein the user is enabled to engage in the second activity, after the user has at least participated in the first activity.

11. A system for enabling a user to overcome lack of self control, the system comprising an activity module configured to:
enable the user to engage in at least a first activity in a virtual environment, wherein the first activity is directed to rewire a first defective wiring of the brain, wherein the first defective wiring results in a tendency to be biased towards short term gratification; and
enable the user to engage in at least a second activity in the virtual environment, wherein the second activity is directed to rewire a second defective wiring of the brain, wherein the second defective wiring results in failure to weigh between short term gratification and long term outcome, wherein symptom of the first and the second defective wirings is lack of self control, wherein engagement in the second activity is enabled after the user has at least participated in the first activity.

12. The system of claim 11, wherein,
the first activity is directed to rewire the first defective wiring to increase the ability to notice the benefits of the long term outcome; and
the second activity is directed to rewire the second defective wiring to increase the ability to weigh between short term gratification and long term outcome.
